(19) United States
(12) Patent Application Publication
(10) Pub. No.: US 2026/0200212 A1
(43) Pub. Date: Jul. 16, 2026

(54) SOLID WOOD GRAIN PAD STRUCTURE AND METHOD OF MANUFACTURING THE SAME

(71) Applicant: SHANGHAI SHENGHE INTELLIGENT TECHNOLOGY CO., LTD, Shanghai (CN)

(72) Inventor: Kefeng MA, Shanghai (CN)

(73) Assignee: SHANGHAI SHENGHE INTELLIGENT TECHNOLOGY CO., LTD, Shanghai (CN)

(21) Appl. No.: 19/563,013

(22) Filed: Mar. 11, 2026

Related U.S. Application Data
(63) Continuation of application No. PCT/CN2024/103506, filed on Jul. 4, 2024.

(30) Foreign Application Priority Data
Sep. 11, 2023 (CN) 202311168711.5

(51) Int. Cl. B32B 21/08; B32B 7/12; B32B 15/09; B32B 15/10; B32B 33/00; B32B 37/02; B32B 37/12; B32B 38/00

(52) U.S. Cl. CPC B32B 21/08; B32B 7/12; B32B 15/09; B32B 15/10; B32B 33/00; B32B 37/02; B32B 38/0004; B32B 2037/1253; B32B 2038/0016; B32B 2250/05; B32B 2255/06; B32B 2255/08; B32B 2255/10; B32B 2255/26; B32B 2307/302; B32B 2307/412; B32B 2311/24; B32B 2367/00

(57) ABSTRACT

A solid wood grain pad structure comprises: a protective layer, a first adhesive layer, an adhesive adhesion undercoat layer, a first pattern effect layer, a UV-sealing coating layer, a natural plant epidermis layer, a second adhesive layer, a first thermal conductive layer, a third adhesive layer, a filling sheet interlayer, a fourth adhesive layer, and a second thermal conductive layer, which are sequentially disposed from top to bottom; and a base sealing resin adhesive edge-banding layer surroundingly adhered to surface layers around outer vertical sides of a pad base. By virtue of physical properties and structural matching of materials of respective layers, while achieving a natural temperature control through a physical means, the present invention really well addresses prominent problems of the solid wood grain coaster panel, such as adhesive layer delamination and base deformation, thereby extending the lifetime of the solid wood grain coaster panel.

### CROSS-REFERENCE TO RELATED APPLICATIONS

This application is a continuation of International Patent Application No. PCT/CN2024/103506 filed on Jul. 4, 2024, which claims priority to Chinese Patent Application No. 202311168711.5 filed on Sep. 11, 2023. The disclosures of the above-referenced applications are hereby incorporated by reference in their entirety.

### TECHNICAL FIELD

The present invention relates to the field of panel processing technology, and specifically to a solid wood grain coaster structure and a method of manufacturing the same. In particular, the present invention relates to an ultra-thin solid wood grain coaster panel with physically temperature control and a method of manufacturing the same.

### BACKGROUND

The aesthetic appeal of natural wood grains is common in home decor and similar applications. Specifically, for coasters, placemats, and tea tray panels used in the field of wine, tea, and coffee cultures, their characteristics of use impose very stringent requirements on thickness, abrasion resistance, water resistance, stain resistance, temperature resistance, heat dissipation, heat insulation, aging resistance, or the like. In particular, there are higher requirements for water resistance, temperature resistance, heat dissipation, heat insulation, and abrasion resistance, to ensure that the coaster base and tabletop body get rid from damage by a high temperature. However, among a lot of problems encountered with conventional coasters, placemats, and tea tray panels in daily life, the most prominent problems lie in that the high-temperature resistance effect is average, the effects on temperature control, heat insulation, and heat dissipation are poor, and surfaces are not wear-resistant, prone to cracking, have poor stain resistance, low strength, and are prone to aging and damage.

The most common coaster substrates currently available on the market are made of the following materials or forms: tempered glass, PVC soft glass, TPU soft glass, tempered film, leather, knitted fabrics, bamboo wood, solid wood, ceramics, metals, handcrafted woven materials, and the like.

As an indispensable accessory in global wine, tea, and coffee cultures, solid wood coasters are commonly used in daily life. However, due to the contacting of water of natural solid wood and the thermal expansion/contraction properties of natural wood, the most significant problems are warping, cracking, discoloration, and scratches, which become to pain points. To address those pain points, manufacturers must rely on premium or rare woods with high air-dry density as primary materials, which limits the selection of the variety and natural grain patterns of primary timber materials, and meanwhile it also leads to problems of low production efficiency, high material waste, elevated timber costs, complex manufacturing processes, high retail prices and the like.

To effectively upgrade conventional solid wood coasters, placemats, and tea tray panels while filling gaps in domestic and international markets, we propose an ultra-thin solid wood grain coaster panel with physically temperature control and a method of manufacturing the same, which may exhibit the aesthetic appeal of natural bamboo and wood grains as much as possible, offer multiple practical benefits such as temperature control, heat insulation and dissipation, slip resistance, scratch resistance, waterproofing, stain resistance, ultra-thin profile, lightweight design, low cost, easy processing, minimal waste, and durability, and also integrate cultural artistry and aesthetic appeal into a single product.

### SUMMARY

In order to address the shortcomings of the prior art, an object of the present invention is to provide a solid wood grain pad structure and a method of manufacturing the same.

A solid wood grain pad structure according the present invention comprises: a protective layer, a first adhesive layer, an adhesive adhesion undercoat layer, a first pattern effect layer, a UV-sealing coating layer, a natural plant epidermis layer, a second adhesive layer, a first thermal conductive layer, a third adhesive layer, a filling sheet interlayer, a fourth adhesive layer, and a second thermal conductive layer, which are sequentially disposed from top to bottom; and a base sealing resin adhesive edge-banding layer surroundingly adhered to surface layers around outer vertical sides of a pad base.

Preferably, a second pattern effect layer is further disposed below the second thermal conductive layer; or, a base material layer is further disposed below the second thermal conductive layer.

Preferably, the protective layer comprises a transparent protective film layer and an antibacterial hardened protective layer sequentially disposed from bottom to top above the first adhesive layer; the first pattern effect layer comprises a first printing effect enhancement undercoat layer and a first pattern printing layer sequentially disposed from bottom to top above the UV-sealing coating layer; the second pattern effect layer comprises a second printing effect enhancement undercoat layer and a second pattern printing layer sequentially disposed from top to bottom below the second thermal conductive layer; the base material layer comprises one or more of a composite cork, a rubber soft magnetic sheet, a felt fabric, a solid-color or faux textured plastic sheet, a solid-color or faux textured metal sheet, a PC plastic plate, a water-absorbing and anti-slip material.

Preferably, the first thermal conductive layer comprises a first graphene heat conduction & dissipation functional layer and a second metal foil layer sequentially disposed from top to bottom; the second thermal conductive layer comprises a third graphene heat conduction & dissipation functional layer and a fourth metal foil layer sequentially disposed from top to bottom.

A method of manufacturing a solid wood grain pad structure according to the present invention comprises the following steps:

a step S1 of material preparation:

pre-processing a PET transparent protective film to form the protective layer;

performing seam processing on a natural plant epidermis to form the natural plant epidermis layer;

processing a metal foil to form the first thermal conductive layer or the second thermal conductive layer; and

processing an interlayer sheet to form the filling sheet interlayer;

a step S2 of preliminary integration:

stacking the natural plant epidermis layer, the first thermal conductive layer, the filling sheet interlayer, and the second thermal conductive layer prepared in the step S1 sequentially from top to bottom and bonding by using an adhesive to form a cover plate base, forming the UV-sealing coating layer on an upper surface of the natural plant epidermis layer of the cover plate base, then forming the first printing effect enhancement undercoat layer on an upper surface of the UV-sealing coating layer, and forming the first pattern printing layer on an upper surface of the first printing effect enhancement undercoat layer after pattern printing;

a step S3 of protective film lamination:

forming the adhesive adhesion undercoat layer on an upper surface of the first pattern printing layer of the cover plate base from the step S2, and adhering the protective layer from the step S1 to the adhesive adhesion undercoat layer;

a step S4 of secondary integration:

forming a pressure-sensitive adhesive layer on an upper surface of the functional base material, then adhering the second thermal conductive layer of the cover plate base with the protective layer from the step S3 to the pressure-sensitive adhesive layer and laminating.

Preferably, for the step S1,

the pre-processing of the PET transparent protective film to form the protective layer, comprises the following sub-steps:

a step S1.1.1 of feeding the PET transparent protective film to be processed through an unwinding shaft and a pressure roller, performing corona or coating processing before being rewound, and completing the corona or coating processing on one side of an upper surface of the PET transparent protective film; and

a step S1.1.2 of applying a hardening solution via roller coating, spraying, or shower coating to the one side of the PET transparent protective film that completed the corona or coating processing, and forming the antibacterial hardened protective layer after drying and curing;

the performing of the seam processing on the natural plant epidermis to form the natural plant epidermis layer, comprises a sub-step S1.2.1 of aligning multiple natural plant epidermises from edge to edge to perform seam adhesion;

the processing of the metal foil to form the first thermal conductive layer or the second thermal conductive layer, comprises the following sub-steps:

a step S1.3.1 of performing a frosting treatment on both front and back surfaces of the metal foil to polish a smooth surface of the metal foil into a rough surface;

a step S1.3.2 of applying a heat dissipation ink via roller coating, spraying, or shower coating to one rough surface of the metal foil treated in the step S1.3.1 to form the first super thermal conductive functional layer; and

a step S1.3.3 of performing cutting to obtain the first thermal conductive layer or the second thermal conductive layer;

the processing of the interlayer sheet to form the filling sheet interlayer, comprises a sub-step S1.4.1 of forming a corona-treated layer on both upper and lower surfaces of a plastic interlayer sheet roll respectively to complete the processing of the filling sheet interlayer.

Preferably, for the step S3, it comprises the following sub-steps:

a step S3.1 of performing adhesion agent coating on the upper surface of the first pattern printing layer of the cover plate base from the step S2, then performing UV light curing to form the adhesive adhesion undercoat layer; and

a step S3.2 of coating a UV liquid transparent adhesive between the protective layer and the adhesive adhesion undercoat layer, then performing the UV light curing to complete the integration and processing of the protective layer.

Preferably, for the step S4, it comprises the following sub-steps:

a step S4.1 of stacking a base of the functional base material onto a feeding platform of a flat laminating machine, loading a pressure-sensitive adhesive roll onto a material unwind air-cushion shaft of the laminating machine for fixation, adhering an upper surface of the functional base material against a pressure-sensitive adhesive surface and synchronously entering and passing through a pressure-sensitive adhesive cold-press composite roller, thereby forming the pressure-sensitive adhesive layer on the upper surface of the functional base material; and

a step S4.2 of adhering the second thermal conductive layer of the cover plate base with the protective layer from the step S3 to the pressure-sensitive adhesive layer and synchronously entering and passing through the cold-press composite roller, thereby completing the integration and processing of the functional base material and the cover plate base.

Preferably, the method further comprises a step S5 of profiling for:

engraving or punching the cover plate base from the step S4 after the secondary integration according to a preset pattern, and polishing peripheral vertical sides of the engraved or punched cover plate base.

Preferably, the method further comprises a step S6 of sealing for:

applying a sealing resin adhesive to the peripheral vertical sides of the cover plate base polished in the step S5 to form the base sealing resin adhesive edge-banding layer.

As compared with the prior art, the present invention provides the following beneficial effects:

1. The present invention employs a multi-layer integrated base of heat conduction, dissipation, and insulation, composed of a first graphene heat conduction & dissipation functional layer, a second aluminum foil thermal conductive functional layer, a PET heat insulation sheet layer, a third graphene conduction & dissipation functional layer, and a fourth aluminum foil thermal conductive functional layer, which are disposed below the natural plant epidermis layer. By virtue of physical properties and structural matching of materials of respective layers, while achieving a natural temperature control through a physical means, the present invention really well addresses prominent problems of the solid wood grain coaster panel, such as adhesive layer delamination, base deformation, orange peel or wave-like wrinkles formed in the protective film layer, and irregular whitening or discoloration locally occurred in the natural plant epidermis layer, which are caused by a high temperature, thereby extending the lifetime of the solid wood grain coaster panel and lasting in good condition.

2. In the present invention, the cover plate base undergoes integrated high-temperature/high-pressure and cold-press molding, the bonding strength and density of each layer of the cover plate base are significantly enhanced, thus making the integrated cover plate base more robust, smoother, and durable.

3. The present invention employs a natural plant epidermis as a surface material and a solid wood grain coaster panel is made thereform. The solid wood grain coaster panel is particularly applicable to tables such as dining table, tea table, and the like, which are frequently exposed to high-heat objects, water, and grease. Covering the original tabletop surface with the solid wood grain coaster panel will deliver multiple practical benefits, such as notable physically heat insulation, physically heat dissipation, slip resistance, scratch resistance, abrasion protection, waterproofing, and stain resistance.

4. Through polishing the surfaces of natural plant epidermises and applying an adhesive on the natural plant epidermis layer using a UV-sealing adhesive coating machine, thereafter performing UV light curing to form a transparent isolating layer, the present invention enables a portion of moisture within the body of the natural plant epidermises to be not discharged and completely isolated from outside, and also reduces bubbles that are ease to occur during lamination between the natural plant epidermis layer 8 and the PET protective film layer caused by the unevenness of natural patterns on the surface of natural plant epidermises, thereby effectively addressing bubble issues in the finished solid wood grain coaster panel and improving the yield of products.

5. By the printing effect enhancement undercoat layer disposed on the upper surface of the natural plant epidermis layer, the present invention facilitates high-definition reproduction of calligraphy or painting patterns directly onto the upper surface of the natural plant epidermis layer via a printer or manual writing, to achieve the aesthetic appeal of artistry and nature in the solid wood grain coaster panel and enhance their visual appeal and artistic effect.

6. The present invention provides tension control and balance among respective functional layers of the cover plate base by the second aluminum foil thermal conductive layer, the filling sheet interlayer, and the fourth aluminum foil thermal conductive layer stacked underneath the natural plant epidermis layer. Issues such as banana-curve like deformation or edge warping that occur during production and use due to the thinness of the solid wood grain coaster panel are solved. It is particularly applicable to coasters, as the body of the solid wood grain panel adheres seamlessly to the support surface and flatness and gapless are achieved, thereby the user experience is enhanced.

7. The natural plant epidermis materials used in the present invention have no selection restriction. In particular, premium global timber species like Phoebe zhennan, yellow rosewood, sandalwood, and walnut can all be processed into thin epidermises. This enhances the natural texture of the solid wood grain coaster panel of the present invention, thereby promoting and popularizing their use in everyday life.

8. As the natural plant epidermises used in the present invention are unrestricted by tree species and leveraging the functional properties of the pad base, the material options for conventional solid wood coasters are broadened, meanwhile their overall cost and price are further reduced.

9. The present invention provides a method of manufacturing an ultra-thin solid wood grain coaster panel with physically temperature control. The cover plate base made thereby can be customized to any overall thickness between 1~10 mm, and any panel dimensions within 1200 mm in length×3000 mm in width. Depending on application environments, usage characteristics, and functional requirements, it can be extended for use in related external industry applications primarily targeted for surface protection and decoration, such as but not limited to coasters, placemats, tea trays, serving trays, game boards, and watch dials.

### BRIEF DESCRIPTION OF THE DRAWINGS

Other features, objects, and advantages of the present invention will become more apparent upon reading the detailed description of non-limiting embodiments with reference to the accompanying drawings:

FIG. 1 is a schematic diagram mainly illustrating an overall structure of a coaster panel according to the present invention;

FIG. 2 is a schematic diagram mainly illustrating a temperature control and heat insulation principle of inner and outer layers of a coaster panel according to the present invention;

FIG. 3 is a schematic diagram mainly illustrating a processing flow of a coaster panel according to the present invention;

FIG. 4 is a schematic diagram mainly illustrating a processing flow and its principle for base material undercoating according to the present invention;

FIG. 5 is a schematic diagram mainly illustrating a cutting process and its principle for base roll material according to the present invention;

FIG. 6 is a schematic diagram mainly illustrating a hot/cold-pressing process and its principle for the cover plate base according to the present invention;

FIG. 7 is a schematic diagram mainly illustrating a polishing process and its principle for the cover plate base according to the present invention;

FIG. 8 is a schematic diagram mainly illustrating a adhesive coating and lamination process and its principle for the cover plate base according to the present invention;

FIG. 9 is a schematic diagram mainly illustrating a undercoat printing process and its principle for the cover plate base according to the present invention;

FIG. 10 is a real-shot photo mainly illustrating the processing of the cover plate base according to the present invention;

FIG. 11 is a real-shot photo mainly illustrating the adhesive coating and lamination processing of the cover plate base according to the present invention;

FIG. 12 is a photo mainly illustrating a processing effect of the cover plate base according to the present invention; and

FIG. 13 is a comparative real-shot photo mainly illustrating an application effect of the solid wood grain coaster panel according to the present invention.

Illustrated in the figures:
Antibacterial Hardened Protective Layer 1
Transparent Protective Film Layer 2
First Adhesive Layer 3
Adhesive Adhesion Undercoat Layer 4
First Pattern Printing Layer 5
First Printing Effect Enhancement Undercoat Layer 6
UV-sealing Coating Layer 7
Natural Plant Epidermis Layer 8
Second Adhesive Layer 9
First Super Thermal Conductive Functional Layer 10
Second Thermal Conductive Functional Layer 11
Third Adhesive Layer 12
Filling Sheet Interlayer 13
Fourth Adhesive Layer 14
Third Super Thermal Conductive Functional Layer 15
Fourth Thermal Conductive Functional Layer 16
Second Printing Effect Enhancement Undercoat Layer 17
Second Pattern Printing Layer 18
Base Sealing Resin Adhesive Edge-Banding Layer 19
Base Material Layer 20

### DETAILED DESCRIPTION

The present invention is described in detail below in conjunction with specific examples. The following examples will assist those skilled in the art in further understanding the present invention, but do not limit the scope of the present invention in any way. It should be noted that, for one of ordinary skill in the art, several modifications and improvements may be made without departing from the concepts of the present invention. These are all within the scope of protection of the present invention.

### Example 1

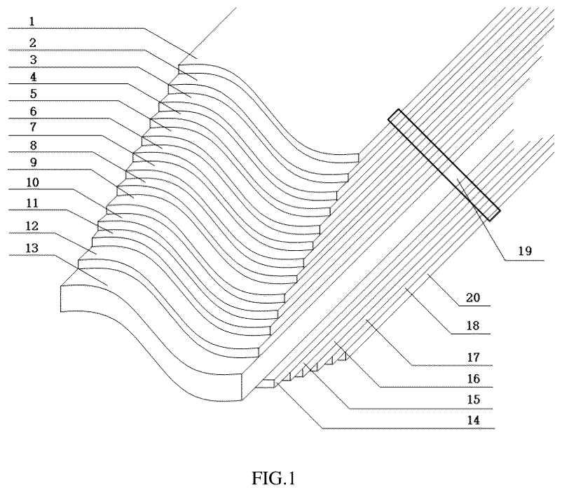

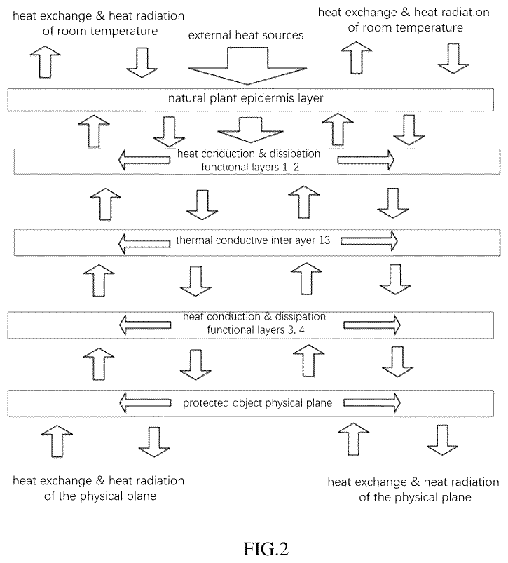

As shown in FIGS. 1 and 2, the present invention provides a solid wood grain pad structure and a method of manufacturing the same. The solid wood grain pad structure comprises: a protective layer, a first adhesive layer 3, an adhesive adhesion undercoat layer 4, a first pattern effect layer, a UV-sealing coating layer 7, a natural plant epidermis layer 8, a second adhesive layer 9, a first thermal conductive layer, a third adhesive layer 12, a filling sheet interlayer 13, a fourth adhesive layer 14, and a second thermal conductive layer, which are sequentially disposed from top to bottom. It further comprises a base sealing resin adhesive edge-banding layer 19 surroundingly adhered to surface layers around outer vertical sides of a pad base. The protective layer comprises a transparent protective film layer 2 and an antibacterial hardened protective layer 1 sequentially disposed from bottom to top above the first adhesive layer 3.

The first thermal conductive layer comprises a first graphene heat conduction & dissipation functional layer and a second metal foil layer sequentially disposed from top to bottom; the second thermal conductive layer comprises a third graphene heat conduction & dissipation functional layer and a fourth metal foil layer sequentially disposed from top to bottom.

A second pattern effect layer is further disposed below the second thermal conductive layer; or, a base material layer 20 is further disposed below the second thermal conductive layer. The second pattern effect layer comprises a second printing effect enhancement undercoat layer 17 and a second pattern printing layer 18 sequentially disposed from top to bottom below the second thermal conductive layer.

Specifically, the first pattern effect layer comprises a first printing effect enhancement undercoat layer 6 and a first pattern printing layer 5 sequentially disposed from bottom to top above the UV-sealing coating layer 7. The base material layer 20 comprises one or more of a composite cork, a rubber soft magnetic sheet, a felt fabric, a solid-color or faux textured plastic sheet, a solid-color or faux textured metal sheet, a PC plastic plate, a water-absorbing and anti-slip material.

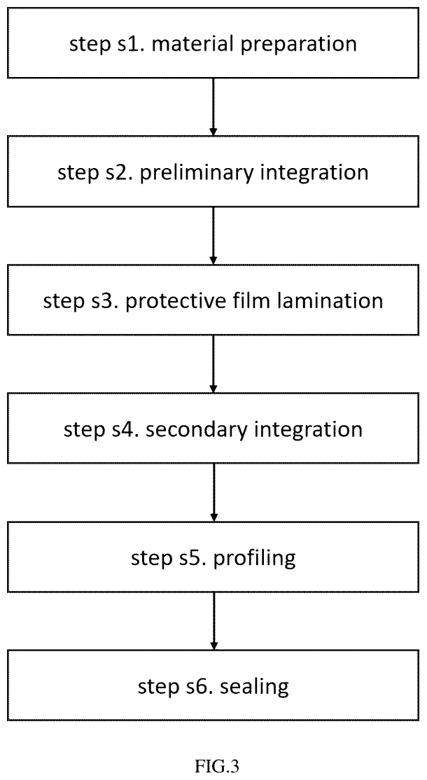

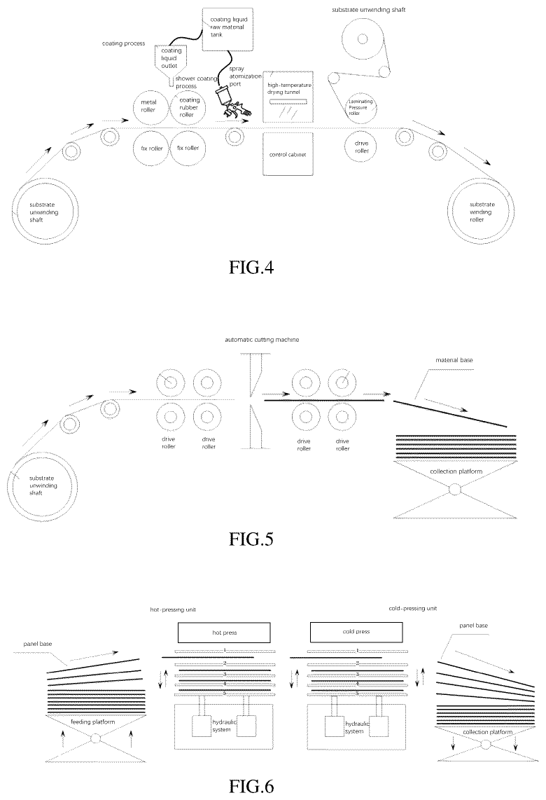

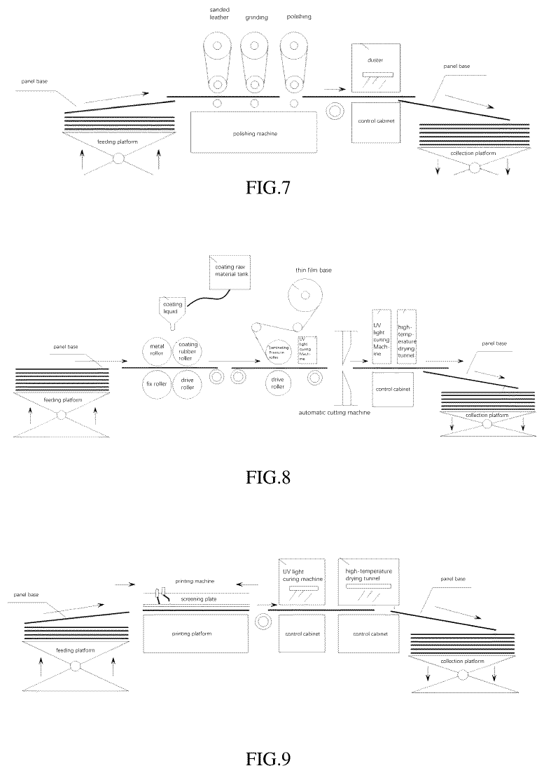

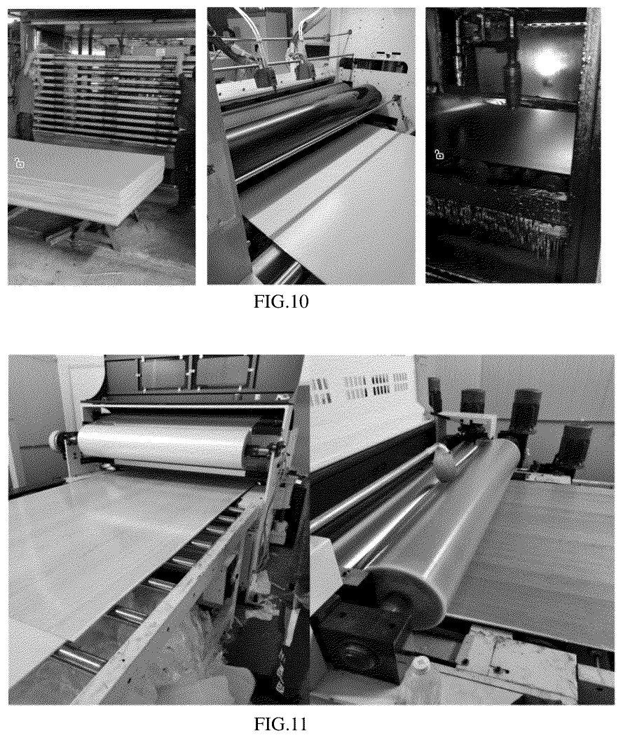

As shown in FIGS. 3-13, the present invention further provides a method of manufacturing a solid wood grain pad structure, the method comprises the following steps:

a step S1 of material preparation:

pre-processing a PET transparent protective film to form the protective layer;

specifically, this step comprises the following sub-steps:

a step S1.1.1 of feeding the PET transparent protective film to be processed through an unwinding shaft and a pressure roller, performing corona or coating processing before being rewound, and completing the corona or coating processing on one side of an upper surface of the PET transparent protective film; and

a step S1.1.2 of applying a hardening solution via roller coating, spraying, or shower coating to the one side of the PET transparent protective film that completed the corona or coating processing, and forming the antibacterial hardened protective layer after drying and curing;

performing seam processing on natural plant epidermises to form the natural plant epidermis layer; specifically, this step comprises a sub-step S1.2.1 of aligning multiple natural plant epidermises from edge to edge to perform seam adhesion;

processing a metal foil to form the first thermal conductive layer or the second thermal conductive layer; and specifically, this step comprises the following sub-steps:

a step S1.3.1 of performing a frosting treatment on both front and back surfaces of the metal foil to polish a smooth surface of the metal foil into a rough surface;

a step S1.3.2 of applying a heat dissipation ink via roller coating, spraying, or shower coating to one rough surface of the metal foil treated in the step S1.3.1 to form the first super thermal conductive functional layer; and

a step S1.3.3 of performing cutting to obtain the first thermal conductive layer or the second thermal conductive layer;

processing an interlayer sheet to form the filling sheet interlayer; specifically, this step comprises a sub-step S1.4.1 of forming a corona-treated layer on both upper and lower surfaces of a plastic interlayer sheet roll respectively to complete the processing of the filling sheet interlayer 13;

a step S2 of preliminary integration:

stacking the natural plant epidermis layer 8, the first thermal conductive layer, the filling sheet interlayer 13, and the second thermal conductive layer prepared in the step S1 sequentially from top to bottom and laminating by using an adhesive to form a cover plate base, forming the UV-sealing coating layer 7 on an upper surface of the natural plant epidermis layer 8 of the cover plate base, then forming the first printing effect enhancement undercoat layer 6 on an upper surface of the UV-sealing coating layer 7, and forming the first pattern printing layer 5 on an upper surface of the first printing effect enhancement undercoat layer 6 after pattern printing; specifically,

a step S3 of protective film lamination:

forming the adhesive adhesion undercoat layer 4 on an upper surface of the first pattern printing layer 5 of the cover plate base from the step S2 4, and adhering the protective layer from the step S1 to the adhesive adhesion undercoat layer 4; specifically, a step S3.1 of performing adhesion agent coating on the upper surface of the first pattern printing layer 5 of the cover plate base from the step S2, then performing UV light curing to form the adhesive adhesion undercoat layer 4; and

a step S3.2 of coating a UV liquid transparent adhesive between the protective layer and the adhesive adhesion undercoat layer 4, then performing the UV light curing to complete the integration and processing of the protective layer.

a step S4 of secondary integration for:

forming a pressure-sensitive adhesive layer on an upper surface of the functional base material, then adhering the second thermal conductive layer of the cover plate base with the protective layer from the step S3 to the pressure-sensitive adhesive layer and laminating. Specifically, this step comprises the following sub-steps:

a step S4.1 of stacking a base of the functional base material onto a feeding platform of a flat laminating machine, loading a pressure-sensitive adhesive roll onto a material unwind air-cushion shaft of the laminating machine for fixation, adhering an upper surface of the functional base material against a pressure-sensitive adhesive surface and synchronously entering and passing through a pressure-sensitive adhesive cold-press composite roller, thereby forming the pressure-sensitive adhesive layer on the upper surface of the functional base material; and

a step S4.2 of adhering the second thermal conductive layer of the cover plate base with the protective layer from the step S3 to the pressure-sensitive adhesive layer and synchronously entering and passing through the cold-press composite roller, thereby completing the integration and processing of the functional base material and the cover plate base.

The method further comprises a step S5 of profiling:

engraving or punching the cover plate base from the step S4 after the secondary integration according to a preset pattern, and polishing peripheral vertical sides of the engraved or punched cover plate base.

The method further comprises a step S6 of sealing:

applying a sealing resin adhesive to the peripheral vertical sides of the cover plate base polished in the step S5 to form the base sealing resin adhesive edge-banding layer 19.

By virtue of physical properties and structural matching of materials of respective layers, while achieving a natural temperature control through a physical means, the technical solution of the present application really well addresses prominent problems of the solid wood grain pad structure, such as adhesive layer delamination, base deformation, orange peel or wave-like wrinkles formed in the protective film layer, and irregular whitening or discoloration locally occurred in the natural plant epidermis layer, which are caused by a high temperature, thereby extending the lifetime of the solid wood grain coaster panel and lasting in good condition.

It should be noted that the technical solution of the present application proposes a solid wood grain pad structure and a method of manufacturing the same, and all applications of the solid wood grain pad structure recited in the technical solution of the present application fall within the scope of protection of the present application. For example, the solid wood grain pad structure recited in the present application can be manufactured into coasters, placemats, tea trays, serving trays, game boards, watch dials, and the like.

### Example 2

Based on Example 1, a solid wood grain pad structure according to the present invention comprises a second pattern printing layer 18 or a base material layer 20, a second printing effect enhancement undercoat layer 17, a fourth thermal conductive functional layer 16, a third super thermal conductive functional layer 15, a fourth adhesive layer 14, a filling sheet interlayer 13, a third adhesive layer 12, a second thermal conductive functional layer 11, a first super thermal conductive functional layer 10, a second adhesive layer 9, a natural plant epidermis layer 8, a UV-sealing coating layer 7, a first printing effect enhancement undercoat layer 6, a first pattern printing layer 5, an adhesive adhesion undercoat layer 4, a first adhesive layer 3, a transparent protective film layer 2, and a hardened protective coating layer 1, which are sequentially stacked from bottom to top. It further comprises a base sealing resin adhesive edge-banding layer 19 surroundingly adhered to surface layers around outer vertical sides of a pad base.

A method of manufacturing a solid wood grain pad structure according to the present invention comprises:

a step S1 of material preparation: preparing a PET transparent protective film, a natural plant epidermis, a heat dissipation coating, a metal foil, a plastic interlayer sheet, a hardening liquid, a hot-melt adhesive, an adhesion adhesive agent, a functional base material, and a sealing adhesive for later use.

Further, the PET transparent protective film is pre-processed to form the protective layer. This comprises a process of feeding the PET transparent protective film to be processed through an unwinding shaft and a pressure roller, performing corona or coating processing before being rewound, and completing the corona or coating processing on one side of an upper surface of the PET transparent protective film. The hardened protective coating layer is a transparent liquid made by mixing multiple substances, which is applied with a coating thickness set to 30 μm via a coating machine to a surface of the 40 μm-thick, 1.25 m-wide transparent protective film layer 22 to form the protective layer. It has properties such as scratch resistance, abrasion resistance, oil resistance, antibacterial, and yellowing resistance, and the surface of the PET transparent protective film layer 22 has a hardness of 3 H or higher.

Further, the natural plant epidermis layer 8 is formed through performing seam processing on the natural plant epidermis. The substrate for the natural plant epidermis layer 8 employs multiple pure natural solid wood sheets with a thicknesses between 0.2 mm and 0.8 mm, a length between 50 cm and 350 cm, and a width between 10 cm and 65 cm as primary materials. These sheets are bonded together by an adhesive to form the natural plant epidermis layer 8 with a length of 3.5 m and a width of 1.25 m.

The wood epidermis splicing processing step comprises:

Material Preparation: preparing a natural plant epidermis raw material for later use. The natural plant epidermis includes bamboo skin, white oak skin, oak skin, teak skin, elm skin, silver pear skin, black walnut skin, engineered wood skin, or the like. The natural plant epidermis raw material has a thickness between 0.2 mm to 0.8 mm, a length between 50 cm to 350 cm, and a width between 10 cm to 65 cm.

Edge Trimming: placing the natural plant epidermis raw material onto a specialized edge trimming equipment, and trimming both edges of the natural plant epidermis to achieve neat, smooth, and even edges.

Texture Classification: manually classifying the surface textures and colors of the natural plant epidermis raw material according to design effects.

Raw Material Splicing: placing several already-classified individual sheets of the natural plant epidermis raw material onto a feeding platform of a specialized adhesive joining equipment, and manually aligning the seams of the natural plant epidermis raw material on the feeding platform before feeding them into an automatic adhesive joining equipment for adhesion and seam connection. The repeated splicing is performed several times, until any design dimensions within 3.4 m in width×1.25 m in length are achieved, thus completing the splicing process of the solid wood epidermis.

Further, the metal foil is processed to form the first thermal conductive layer or the second thermal conductive layer. Both the second thermal conductive functional layer and the fourth thermal conductive functional layer are comprised of aluminum foil or other metal foil roll materials. Surface pretreatment employs roll-to-roll frosting and roughening, and after the aluminum foil roll material is loaded onto an unwinding shaft of a wire drawing machine for fixation, the aluminum foil is then fed through a frosting and wire drawing structure inside the flat wire drawing machine. Upon releasing from a frosting and wire drawing device, a smooth surface of the aluminum foil will become rough. The pretreated aluminum foil is then fixed onto the unwinding shaft via rewinding until the process is complete. The key advantage of surface roughening and wire drawing pretreatment for the aluminum foil lies in its role as the core base layer for either the first super thermal conductive functional layer 10 or the third super thermal conductive functional layer 15. This significantly increases adhesion between a surface of the aluminum foil and the thermal conductive ink, as well as between the surface of the aluminum foil and the hot-melt adhesive layer. If this aluminum foil surface pretreatment step is omit, it will significantly reduce the adhesion and bonding strength between materials, and is prone to delamination.

The substrate for the first super thermal conductive functional layer 10 is made from graphene-based high thermal conductivity material. It undergoes one of the following processes: coating, spraying, brush coating, dip coating, or tank coating, via a specialized equipment. By employing a preferred one of the coating or spraying, a graphene coating liquid is filled into a coating liquid raw material tank. The graphene coating liquid is conveyed by a liquid conveyor to a coating liquid outlet, where it is either applied to a rubber roller surface of the coating machine, or conveyed to a spray atomization port for pressurized atomization and spraying. The aluminum foil roll material of the second thermal conductive functional layer is loaded to the unwinding shaft of the coating machine for fixation. Propelled by a conveyor mechanism, the aluminum foil substrate passes below the surface of the rubber coating roller or downstream of the spray atomization port. As the aluminum foil substrate passes through a coating processing unit, a graphene heat dissipation coating with a wet film thickness of 100 μm and a width within 1.3 m will form on its front surface. Subsequently, at a speed of 1~3 m/min and a baking temperature set between 120~150 degrees Celsius, the graphene wet film adhered to the aluminum foil substrate surface is fully baked and cured within a high-temperature drying tunnel oven having a length of >25m for 5~20 minutes, so that the film thickness will become an actual dry film thickness of 20 μm. Finally, the substrate is wound onto the unwinding shaft until the coating process for the aluminum foil roll material of the second thermal conductive function layer ends.

The first super thermal conductive functional layer 10 uses the graphene material as a heat dissipation function layer, offering the following key advantages: the graphene thermal conductive layer covering the aluminum foil surface of the second thermal conductive functional layer has a hardness of ≥B, a adhesion of level 0, over 20 cycles from −20 to 200 degrees Celsius of hot/cold shock, an adequate temperature range between −50~150 degree Celsius, horizontal thermal conductivity of ≥40 w/mk, vertical thermal conductivity of ≥20 w/mk, thermal emissivity of >0.95, impact resistance of 50 cm, and free of toxic or hazardous substances. The aluminum foil of the second thermal conductive functional layer serves as a graphene substrate. Although the aluminum's thermal conductivity is significantly lower than the graphene's, its use as the base material will effectively synergize and assist the thermal conduction of the graphene layer.

The formation of the second adhesive layer 9 involves two different processing methods and sequences. The change of methods and sequences is determined by the environment of application and temperature conditions of the solid wood grain coaster panel. For regions predominantly experiencing severe cold, an irreversible hot-melt adhesive is employed as the adhesive bonding layer between the natural plant epidermis and the first super thermal conductive functional layer 10. The processing step of forming the second adhesive layer 9 will be completed after the integration process of the metal base (S2.2.3).

For regions dominated by combustion heat environments, a reversible hot-melt adhesive will be used as the adhesive bonding layer between the natural plant epidermis and the first super thermal conductive functional layer 10. The processing step of forming the second adhesive layer 9 will be completed in advance after the super thermal conductive functional layer is fabricated. The key advantage of using the irreversible hot-melt adhesive is its molecular stability and resistance to delamination, particularly in a sub-zero temperature. However, its drawbacks are also significant. Beyond a higher material cost as compared to the reversible hot-melt adhesive, it is more important that the natural plant epidermis and the cover plate base cannot be integrated in a single process. This necessitates separate secondary processing, leading to increased production steps, material wastage, and costs. The key advantage of using the reversible hot-melt adhesive is that for an environment temperature above zero degree, except that its molecular is stable without degumming and delamination, the most notable feature is that the natural plant epidermis can be integrated together with the cover plate base in a single process, thus significantly enhancing production efficiency and reducing overall production costs.

The processing of the second adhesive layer 9 employs a flat roll-to-roll coating method. The aluminum foil roll material of the second thermal functional layer pre-coated with the graphene thermal conductive coating layer is loaded to a substrate unwinding shaft of the laminating machine for fixation. A 50 μm-thick hot-melt adhesive film roll is loaded to an unwinding shaft of the laminating machine for fixation. The first graphene heat conduction & dissipation functional layer is adhered against the adhesive-coated side of the hot-melt adhesive film. The temperature of the laminating pressure roller of the laminating machine is set to 145 degree Celsius, and its operating speed is adjusted to 10 m/min. Propelled by the feeding transmission mechanism, the first graphene heat conduction & dissipation functional layer and the hot-melt adhesive film are simultaneously conveyed and passed through the laminating pressure roller, thereby forming the lamination processing of the second adhesive layer 9 on the upper surface of the first graphene heat conduction & dissipation functional layer before being rewound.

The second thermal conductive layer is slitted using the aluminum foil or other metallic foil with a thickness of 210 μm and a width within 3.4 m as the core material. The aluminum foil roll material for the third thermal conductive layer is loaded to the substrate unwinding shaft for fixation. The stepper feed cutting pitch dimension system is set to any size within 3.2 m. Propelled by the feeder's drive rollers, the substrate will pass below the automatic cutting machine's blades. It is cut and dropped every 3.2 meters according to a preset cutting pitch dimension. The cut roll substrate will form individual sheets with a length of 3.2 m and a width of 1.3 m. These individual sheets are feed by the drive roller 4 to a collection platform, where they are stacked until the cutting is complete.

The function and principle of the second thermal conductive layer are as follows: it serves as the base material for the first super thermal conductive layer 10 (graphene-coated thermal conductive layer), it not only assists an inner layer of the cover plate base in facilitating horizontal and vertical thermal conduction, heat diffusion, thermal radiation, and heat exchange both upward and downward, the second thermal conductive functional layer, when integrated with the lower plastic interlayer sheet layer and the fourth thermal conductive functional layer, achieves the technical characteristic of upper-lower planar tension balance. This ensures overall flatness and tight bonding when the cover plate base adheres to other objects horizontally. The key advantage of using the aluminum foil as the core thermal conductor and tension balancer lies in its excellent thermal conductivity, lightweight nature, ease of shaping and flattening, low processing cost, corrosion resistance, and rust prevention. When used together with the first super thermal conductive functional layer 10 (graphene material), through the property of its inherent thermal conduction, heat is synchronously transferred downward to the plastic interlayer sheet layer, the third super thermal conductive functional layer 15 (graphene), the fourth thermal conductive functional layer (aluminum foil), and ultimately to the protected physical plane. Thermal energy is sequentially dissipated in a layered manner during being transferred to each individual functional layer. Ultimately, the residual heat of the fourth thermal conductive functional layer is fully consumed by virtue of the natural ambient temperature of the protected physical plane to achieve a technical effect of temperature control and temperature drop, thus achieving effective temperature control and temperature drop protection of the protected physical plane as well as the upper surfaces of the cover plate base and the natural plant epidermis.

Further, an interlayer sheet is processed to form the filling sheet interlayer 13. The substrate for the interlayer sheet employs a PET plastic material with a thickness of 210 μm and a width of 1.3 m. Its surface treatment involves feeding the plastic interlayer sheet roll into a corona machine to subject the surfaces of the plastic sheet to electrical impact. This process roughens and fuzzifies the surfaces while creating pits, enhancing a wetting effect when the adhesive layer contacts its surfaces and thereby improving bonding strength. If this step is omit, it will significantly reduce the bonding strength between both front and back surfaces of the base of the interlayer sheet and the third adhesive layer 12 or the fourth adhesive layer 14, leading to potential delamination and poor adhesion.

A method for forming the third adhesive layer 12 involves feeding the plastic interlayer sheet roll, which has undergone the corona treatment step, into a hot-melt adhesive coating machine for coating. The entire process includes unwinding, coating, drying/curing, and rewinding, forming the third adhesive layer 12 on an upper surface of the interlayer sheet.

Interlayer Sheet Slitting Processing: the finished interlayer sheet roll material is loaded to the substrate unwinding shaft for fixation. The stepper feed cutting pitch dimension system is set to 3.2 m. Propelled by the feeder's drive rollers, the substrate will pass below the automatic cutting machine's blades. It is cut and dropped every 3.2 meters according to a preset cutting pitch dimension. The cut roll substrate will form individual sheets with a length of 3.2 m and a width of 1.3 m. These individual sheets are feed by the drive roller to a collection platform, where they are stacked until the cutting is complete.

The processing method for forming the fourth adhesive layer 14 is to stack the interlayer sheet which has completed the slitting step onto a first feeding platform of the hot-melt adhesive laminating machine, load the hot-melt adhesive film to a second feeding air-cushion shaft for fixation, adhere an opposite side of the interlayer sheet coated with the third adhesive layer 12 against the adhesive-coated side of the hot-melt adhesive film, simultaneously feed them between the heated pressure rollers of the laminating machine and pass, and after the fourth adhesive layer 14 at the end of the interlayer sheet is cut by the cutting machine, form the fourth adhesive layer 14 on the surface of the interlayer sheet facing away from the third adhesive layer 12.

A specific processing method for the third super thermal conductive functional layer 15 is as follow: the processing method thereof is the same as that of the first super thermal conductive functional layer 10, and because it is easy to understand, it will not be repeated here. However, the difference lies in that the third super thermal conductive functional layer 15 (graphene coating layer) adheres to the fourth adhesive layer 14 of the filling sheet interlayer 13. It adheres to or is adjacent to the physical plane requiring temperature-controlled protection through the fourth super thermal conductive functional layer at an opposite direction. When the third superconducting thermal conductive functional layer 15 (graphene coating layer) directly adheres to the fourth adhesive layer 14, it will immediately receive heat from the upper natural plant epidermis layer 8 through the filling sheet interlayer 13, and through physical heat dissipation properties of the third super thermal conductive functional layer 15 (graphene coating layer) and the fourth thermal conductive functional layer, the received heat is further distributed within the inner space of the cover plate base via horizontal and vertical heat conduction, heat diffusion, heat radiation, and heat exchange in all directions and peripheries, thereby realizing a physical temperature control effect.

The printing effect enhancement undercoat layer is formed by inline coating. A specific processing method involves filling a printing effect enhancement coating liquid into a coating liquid raw material tank. The printing effect enhancement coating liquid is conveyed by a liquid conveyor to a coating liquid outlet, where it is either applied to a rubber roller surface of the coating machine, or conveyed to a spray atomization port for pressurized atomization and spraying. The aluminum foil roll material of the third super thermal conductive functional layer 15 is loaded to the unwinding shaft of the coating machine for fixation. The surface of the third super thermal conductive functional layer 15 facing away from the fourth thermal conductive functional layer is toward the direction of the coating rubber roller. Propelled by a conveyor mechanism, the aluminum foil substrate passes below the surface of the rubber coating roller or downstream of the spray atomization port. As the aluminum foil substrate passes through a coating processing unit, a printing effect enhancement coating with a thickness of 20 μm will form on its front surface. Subsequently, at a speed of 1~3 m/min and a baking temperature set between 120~150 degrees Celsius, the printing effect enhancement coating wet film adhered to the aluminum foil substrate surface is fully baked and cured within a high-temperature drying tunnel oven having a length of >25 m for 5~20 minutes, so that the film thickness will become an dry film thickness of 10 μm. Finally, the substrate is wound onto the unwinding shaft until the coating process for the printing effect enhancement undercoating layer ends. The key function of using the printing effect enhancement undercoat layer is to significantly improve the effect of patterns printed on the surface of the third super thermal conductive functional layer 15 and ensure that the printing ink has higher adhesion.

The fourth thermal conductive functional layer is made by using an aluminum foil or other metallic foil with a thickness of 210 μm and a width of 3.2 m as the core material, with the aluminum foil being preferred, and its function, characteristics, application method, and principle are same as those of the aluminum foil of the second thermal conductive functional layer serving as the graphene substrate, and because it is easy to understand, it is not repeated here. Its slitting and processing method is same as that of the second thermal conductive functional layer, and because it is easy to understand, it is not repeated here.

Further, the preliminary integration comprises one of the following two processing methods.

### S2.1. First Method and Steps

S2.1.1. Base Material Preparation: prepare the natural plant epidermis layer 8, the second thermal conductive functional layer 11, the filling sheet interlayer 13, and the fourth thermal conductive functional layer for later use;

S2.1.2. Stack a laminated steel plate, a hot-pressed rubber cushion, the natural plant epidermis layer 8, the second thermal conductive functional layer 11, the filling sheet interlayer 13, the fourth thermal conductive functional layer 16, and the laminated steel plate sequentially from bottom to top, adhere the hot-pressed rubber cushion to the laminated steel plate, adhere the hot-pressed rubber cushion to the natural plant epidermis layer 8, adhere the natural plant epidermis layer 8 to the second adhesive layer 9, adhere the second thermal conductive functional layer to the third adhesive layer 12, adhere the third super thermal conductive functional layer 15 to the fourth adhesive layer 14, and adhere the laminated steel plate to the fourth thermal conductive functional layer 16. The advantage of using the laminated steel plate, the hot-pressed rubber cushion, and the laminated steel plate is that the laminated steel plates ensure uniform and smooth overall temperature across the cover plate base when being integrated through heating and pressing. The function of the hot-pressed rubber cushion is to ensures more uniform stress distribution across inner layers of the natural plant epidermis and the cover plate base, and respective layers of the cover plate base, during the hot/cold pressing. If this step is omit, it will cause delamination, false adhesion, bubble swelling, etc. in the integrated cover plate base due to uneven temperature and stress distribution.

S2.1.3. Place the stacked cover plate base with all functional layers onto a feeding platform one by one, set the temperature of a flat hot-pressing plate in a hot-pressing unit to a constant temperature of 90° C., the pressure holding time to 60 seconds, and the pressure holding force to 1500 Mpa, feed the cover plate base placed onto the feeding platform into a compartment of the hot-pressing unit one by one, and perform the hot-pressing on the cover plate base according to a parameter setting, to ultimately achieve the integration of the cover plate base. Subsequently, the hot-pressed cover plate base is feed into a compartment of a cold-pressing unit one by one. Based on preset parameters for the cold-pressing unit, the temperature of the flat cold-pressing plate is set to a constant temperature of 5° C., the pressure holding time is set to 60 seconds, and the pressure holding force is set to 1500 MPa. This ultimately achieves a low-temperature shaping of the hot-pressed cover plate base. Subsequently, the cold-pressed, shaped cover plate base is transferred to the collection platform for stacking and storage. The advantages of integrating the cover plate base by hot-pressing plus cold-pressing are that the bonding strength between respective functional layers of the cover plate base is more uniform due to sustained high temperature and pressure; the substrate base undergoes sustained low temperature and high pressure for the second time after being removed from the furnace, so that rapid cooling and absolute stabilization of the panel substrate is achieved, and peak bonding strength and material density are achieved between the respective functional layers to ultimately yield a composite base panel that is uniformly flat, rigid, yet flexible and resilient. This facilitates subsequent processing while serving as a critical prerequisite for ensuring the overall quality and user experience of the present invention—an ultra-thin solid wood grain coaster panel with physical temperature control. It should be particularly noted that during the process where the respective functional layers are stacked and bonded, the release paper adhered to each adhesive layer surface is pre-peeled before layer integration.

### S2.2. Second Method and Steps

S2.2.1. Base Material Preparation: prepare the natural plant epidermis layer 8, the second thermal conductive functional layer 11, the filling sheet interlayer 13, the fourth thermal conductive functional layer 16, and a PUR hot-melt adhesive for later use;

S2.2.2. Metal Base Stacking Processing: stack and adhere the opposite sides of the second thermal conductive functional layer 11 and the first super thermal conductive functional layer 10 against the third adhesive layer 12, the fourth adhesive layer 14, and the fourth thermal functional conductive layer 16 sequentially from bottom to top;

S2.2.3. Metal Base Assembly Processing: feed the completed metal stacking base into a flat hot press for high-temperature, constant-pressure integration and cold pressing to complete the integration and processing of the cover plate base;

S2.2.4. Processing Method for the Second Adhesive Layer 9: load and stack the cover plate base that has completed the metal base integration step onto the first feeding platform of the laminating machine, load the natural plant epidermis that has completed the seam processing onto the second feeding platform of the laminating machine for stacking, position the opposite side of the printing enhancement undercoat layer formed in the cover plate base in the backside direction of the natural plant epidermis, and after introducing the cover plate base and passing it through the hot-melt adhesive coating roller of the laminating machine PUR by virtue of the driving of the feeding mechanism, form a PUR hot-melt adhesive wet film on the upper surface of the first super thermal conductive functional layer 10 of the cover plate base, thereby forming the second adhesive layer 9.

S2.2.5. Integration & Processing Method for the Natural Plant Epidermis:

adhere the cover plate base with the second adhesive layer 9 bearing the PUR hot-melt adhesive wet film, which has completed the processing step, with the natural plant epidermis from side to side before entering the laminating pressure roller, and after introducing into and passing through the composite pressure roller of the laminating machine by virtue of the driving of the feeding mechanism, complete the integration and processing of the natural plant epidermis and the cover plate base.

S2.3. Stack the cold-and hot-pressed integrated cover plate base above the feeding platform of the polishing machine one by one, and under the force of the drive shaft, sequentially introduce the cover plate base into the polishing machine, and place the cover plate base onto the collection platform for storage after polishing the surfaces of the natural plant epidermis of the cover plate base by sanded leather, grinding, and polishing. Since the natural plant epidermis on the upper surface of the cover plate base is a solid wood plant epidermis, the key advantage of using the polishing step is to remove impurities from the surfaces of the natural plant epidermis 8. This renders the surfaces of the solid wood plant epidermis smooth and burr-free, eliminates noticeable unevenness, and ensures neat and clear natural grain patterns. This also ensures that the surfaces of the natural plant epidermis are smooth and clean during subsequent lamination processing of the transparent protective film layer 2, to prevent visible imperfections like wood fibers from the underlying solid wood plant epidermis which are seen through the transparent PET protective film layer after lamination. If the polishing step is omit, it will result in visible imperfections below the PET protective film layer, including noticeable unevenness, burrs, bubbles, and indistinct natural grain patterns.

S2.5. Stack the polished cover plate base above the feeding platform of a screen printing machine one by one, and propelled by the transmission mechanism, sequentially introduce the cover plate base onto the printing platform of the screen printing machine, position the printing head unit vertically against the upper surface of the natural plant epidermis of the cover plate base, evenly spread UV-sealing coatings across the screen plate from left to right using a squeegee to drive the screen plate, then the printing squeegee synchronously descends with the screen plate until it contacts the upper surface of the cover plate base, and by moving the printing squeegee from right to left, evenly spreads the UV-sealing coatings across the upper surface of the natural plant epidermis of the cover plate base, thereby forming a 30 μm-thick UV-sealing wet film. Propelled by the transmission mechanism, the cover plate base passes through the UV-light curing machine at a speed of 7 m/min, to complete UV light curing of the UV-sealing wet film to form the UV-sealing coating layer 7, and subsequently, the cover plate base is transferred to the collection platform for stacking and storage. The key advantage of using the UV-sealing coating layer 7 is to apply an UV-sealing primer on the upper surface of the natural plant epidermis, thereafter perform the UV light curing to form a transparent isolating layer, which can cause a portion of moisture within the body of the natural plant epidermis to be not discharged and completely isolated from outside, and also reduces bubbles that are ease to occur during lamination between the natural plant epidermis layer 8 and the PET protective film layer 2 caused by the unevenness of natural patterns on the surface of natural plant epidermises, thereby effectively addressing bubble issues in the finished solid wood grain coaster panel and improving the yield of products.

S2.6. Stack the cover plate base in which the UV-sealing coating layer 7 is completed above the feeding platform of a screen printing machine one by one, and propelled by the transmission mechanism, sequentially introduce the cover plate base onto the printing platform of the screen printing machine, position the printing head unit vertically against the upper surface of the natural plant epidermis of the cover plate base, evenly spread printing effect enhancement UV coatings across the screen plate from left to right using a squeegee to drive the screen plate, then the printing squeegee synchronously descends with the screen plate until it contacts the upper surface of the cover plate base, and by moving the printing squeegee from right to left, evenly spreads the printing effect enhancement UV coatings across the upper surface of the UV-sealing coating layer 7 of the cover plate base, thereby forming a 10 μm-thick printing effect enhancement UV coating wet film. Propelled by the transmission mechanism, the cover plate base passes through the UV-light curing machine at a speed of 7 m/min, to complete UV light curing of the UV coating wet film to form the printing effect enhancement coating layer, and subsequently, the cover plate base is transferred to the collection platform for stacking and storage. The main function of using the printing effect enhancement undercoat layer is to significantly improve the effect of patterns printed on the surface of the UV-sealing coating layer 7 and ensure that the printing ink has a relatively high adhesion.

S2.7. The method for manufacturing patterns of the pattern printing layer includes: UV photo printing, thermal transfer, authentic calligraphy/painting, intangible cultural heritage crafts, engraving, and other artistic forms of patterns and text. These are presented as a background in conjunction with the natural grain of the natural plant epidermis layer 8 as the substrate, with the patterns being applied to the surface of the printing effect enhancement coating. The pattern printing layer organically integrates cultural creativity with nature, significantly elevating the artistic and aesthetic appeal of the ultra-thin solid wood grain coaster panel with physical temperature control of the present invention.

Further, the protective film lamination comprises:

preparing materials such as a PET transparent protective film, a UV adhesive, a adhesion-enhancing adhesive, and a cover plate base for later use.

The adhesive adhesion undercoat layer 4 is a transparent coating printed on the upper surface of the pattern printing layer, and is a undercoat transparent layer to enhance the bonding strength of the first adhesive layer 3. The processing procedure is to stack the cover plate base completed and with the pattern printing effect above the feeding platform of a screen printing machine one by one, and propelled by the transmission mechanism, sequentially introduce the cover plate base onto the printing platform of the screen printing machine, position the printing head unit vertically against the upper surface of the natural plant epidermis of the cover plate base, evenly spread adhesive adhesion coatings across the screen plate from left to right using a squeegee to drive the screen plate, then the printing squeegee synchronously descends with the screen plate until it contacts the upper surface of the cover plate base, and by moving the printing squeegee from right to left, evenly spreads the adhesive adhesion coatings across the upper surface of the pattern printing layer of the cover plate base, thereby forming a 10 μm-thick wet film for the adhesive adhesion undercoat layer 4. Propelled by the transmission mechanism, the cover plate base passes through a high-temperature drying tunnel set at 80 degree Celsius at a speed of 5 m/min, to complete far-infrared curing of the wet film for the adhesive adhesion undercoat layer 4, and subsequently, the cover plate base is transferred to the collection platform for stacking and storage.

The first adhesive layer 3 is a transparent liquid UV adhesive applied to the transparent protective film layer 2 on the upper surface of the cover plate base. The processing procedure is to stack the cover plate base on the feeding platform of the laminating machine, inject the UV adhesive into the coating raw material tank, and then convey the UV adhesive liquid via the coating conveyor to the coating rubber roller, where it covers the roller surface. Propelled by the power transmission mechanism of the laminating machine, the cover plate base passes through the coating rubber roller, forming an 80 μm-thick, 1.25 m-wide UV adhesive wet film on its surface. Using the UV adhesive as the core material for the adhesive layers offers the following key advantage: this enables seamless, secure bonding with the PET transparent protective film layer 2, clearly revealing the natural grain of the natural plant epidermis layer 8 and the patterns of the pattern printing layer through the transparent protective film layer 2. After curing by a UV lamp, an adhesion strength of >15 kg is achieved. The key advantage of using the UV adhesive to adhere the PET transparent protective film layer 2 include: fast curing speed, light-curing temperature below 70 degree Celsius, minimal shrinkage of the PET transparent protective film, strong adhesion without delamination, and no issues such as delamination, adhesive failure, or deformation caused by a high temperature and affecting the internal structure of the cover plate base of the coaster panel. If the UV adhesive is not used as the core adhesive material for the adhesive layers, and instead a PUR hot-melt adhesive tape transparent film lamination process is employed, due to the properties of the PUR adhesive, the PUR hot-melt adhesive layer attached to the PET transparent protective film must first be heated to 150 degree Celsius or above to melt it before lamination, followed by a process of laminating via the laminating machine roller. This method is well suitable for conventional decorative panel lamination. However, for the ultra-thin real wood grain coaster panel with physical temperature control of the present invention, since the cover plate base features multiple internal composite layers, numerous adhesive layers, diverse non-homogeneous materials, thin thickness, and high integration, a high temperature will cause the following issues in the cover plate base: the high shrinkage ratio of the PET transparent protective film layer 2 directly causes the entire cover plate base of the solid wood grain coaster panel of the present invention to exhibit significant banana-curve after lamination. Simultaneously, bubbles will occur between the transparent protective film layer 2 and the natural plant epidermis layer 8 of the solid wood grain coaster panel, and uncontrollable issues such as orange peel texture, wave-like texture, localized delamination, layer separation, deformation, and blistering appear on the surface of the transparent protective film layer 2 and at unpredictable locations within the inner layers of the cover plate base. This results in low product yield and production efficiency, coupled with high material costs as well as elevated production and repair expenses.

The transparent protective film layer 2 is a transparent protective film layer on the upper surface of the natural plant epidermis layer 8 of the cover plate base. The lamination process involves: after applying the UV adhesive coating for the first adhesive layer 3, the cover plate base surface, coated with a UV adhesive wet film, passes through the laminating pressure roller again. During this passage, the base of the transparent protective film and the UV adhesive wet film of the cover plate base roll together under the pressure of the laminating pressure roller, adhering to each other. Simultaneously, under UV-light curing in the UV curing machine, the initial curing and adhesion of the base of the transparent protective film and the UV adhesive wet film of the cover plate base is achieved. Subsequently, the UV adhesive liquid undergoes secondary deep curing in the UV curing machine, thereby completing the full lamination of the transparent protective film layer 2 onto the cover plate base containing the natural plant epidermis layer 8.

Below the fourth thermal conductive functional layer, the printing effect enhancement undercoat layer, the pattern printing layer, or the functional base material layer are stacked from bottom to top, or the space may be left empty. Specifically, for the solid wood grain coaster panel, if the printing effect enhancement undercoat layer and the pattern printing layer are stacked, the functional base material layer will be omitted. Specifically, for the solid wood grain coaster panel, if the printing effect enhancement undercoat layer and the pattern printing layer are omitted, the base material layer will be present or omitted simultaneously.

The processing method for the pattern printing layer is to stack the cover plate base in which the PET transparent protective film is completed above the feeding platform of a screen printing machine one by one, and propelled by the transmission mechanism, sequentially introduce the cover plate base onto the printing platform of the screen printing machine, position the printing head unit vertically against the opposite surfaces of the third super thermal conductive functional layer 15 and the fourth thermal conductive functional layer, evenly spread the printing ink across the screen plate from left to right using a squeegee to drive the screen plate, then the printing squeegee synchronously descends with the screen plate until it contacts the upper surface of the cover plate base, and by moving the printing squeegee from right to left, evenly spreads the printing ink across the upper surface of the printing effect enhancement undercoat layer, thereby forming a 10 μm-thick pattern printing layer. Propelled by the transmission mechanism, the cover plate base passes through the UV-light curing machine at a speed of 7 m/min, to complete UV light curing of the pattern printing layer, and subsequently, the cover plate base is transferred to the collection platform for stacking and storage.

Further, the secondary integration comprises the following steps:

Material Preparation: prepare the pressure-sensitive adhesive material, the functional substrate material, and the cover plate base for later use.

The cork substrate roll material is loaded to a substrate unwinding shaft of the laminating machine for fixation. A 15 μm-thick pressure-sensitive adhesive film roll material is loaded to an unwinding shaft of the laminating machine for fixation. The surface on one side of the cork is adhered against the adhesive-coated side of the pressure-sensitive adhesive film. The temperature of the laminating pressure roller of the laminating machine is set to 0 degree Celsius, and its operating speed is adjusted to 20 m/min. Propelled by the feeding transmission mechanism, the cork substrate and the pressure-sensitive adhesive film are simultaneously conveyed and passed through the laminating pressure roller, thus forming the pressure-sensitive adhesive film on the upper surface of the cork substrate before being rewound.

The cork substrate roll material which has complete the processing step is loaded to the unwinding shaft of the laminating machine for fixation. The completed cover plate base is stacked onto the feeding platform of the laminating machine. Propelled by the feeding transmission mechanism, the cover plate base is conveyed and passes through the laminating pressure roller. Simultaneously, an end of the pressure-sensitive adhesive film of the cork substrate which is fixed to the unwinding shaft passes through intermediate transition rollers and the laminating pressure roller. The adhesive-coated side of the pressure-sensitive adhesive film adheres to the printing effect enhancement undercoat layer on the cover plate base. Propelled by the transmission mechanism and the laminating pressure roller, as the cover plate base and the cork substrate material move from front to back, the pressure-sensitive adhesive is adhered. Upon passing through the automatic film cutter, the pressure-sensitive adhesive film attached to the tail of the cork substrate material is cut and automatically guided by the film cutter to the collection platform, completing the secondary integration and processing. The key advantage of using the cork substrate in a roll form is high production efficiency. Besides, the cork substrate can be adhered as individual sheets to the cover plate base.

It is particularly noted that the secondary integration process for bonding the cork substrate to the cover plate base is a selective procedure contingent upon the absence of the pattern printing layer or depending on whether or not the absence of the pattern printing layer necessitates the secondary integration process.

Further, the profiling process comprises the following steps:

introducing the cover plate base into an engraving machine to perform engraving according to its actual dimensions as designed, then separating the engraved cover plate base from the main cover plate base and existing independently, thus forming a profiled cover plate base matching the designed dimensions and shape.

The engraved and profiled cover plate base is placed on the processing platform of the edging machine for fixation, vertical sides around the profiled cover plate base are lightly contacted with an edging grinding wheel rotating at a high speed, and after the edging grinding wheel is driven by movement of the driving mechanism to grind around the profiled cover plate base for one week, the tool marks and burrs formed on the vertical sides around the profiled cover plate base due to the engraving will be ground away and become smooth.

Further, the sealing process comprises the following steps:

Preparing Materials: single-component sealing resin adhesive and toner;

Resin Adhesive Toning: the toner is injected into the sealing resin adhesive container in proportion and evenly stirred according to an actual base color of the natural plant epidermis, thereby forming the same color sealing resin adhesive close to the actual base color of the natural plant epidermis.

The cover plate base is placed on the processing platform of the edge-banding machine for fixation, the toned sealing resin adhesive is injected into the adhesive box of the edge-banding machine, the sealing resin adhesive is introduced and covered on the upper surface of a coat stick of the edge-banding machine through a rubber hose of the edge-banding machine, the vertical sides of the cover plate base is lightly contacted with the coat stick of the edge-banding machine, and after the coat stick of the edge-banding machine is driven by movement of the driving mechanism to wrap around the cover plate base for adhesion for one week, a wet film layer of the base sealing resin adhesive will be formed on the vertical sides of the cover plate base. The cover plate base with the sealing resin adhesive is introduced into a baking room with a constant temperature of 70 degrees one by one and allowed to stand for 30 minutes to complete drying and curing of the sealing resin edge-banding adhesive, so as to form the sealing resin adhesive edge-banding layer 19 of the base, and then the cover plate base is placed on the processing platform of the chamfering machine for fixation. The vertical sides of the cover plate base containing the sealing resin adhesive layer are lightly contacted with the grinding wheel of the chamfering machine, and after the grinding wheel is driven by movement of the driving mechanism to grind around the cover plate base for one week, a 90-degree right angle of the vertical sides of the cover plate base will become round and the surfaces of the sealing resin adhesive layer become smooth and are free of burrs. The advantage of using the sealing resin adhesive is that it can effectively prevent water or moisture from invading the inside of the cover substrate through the vertical sides around the cover plate base, thus leading to possible delamination. At the same time, the visual beauty of the vertical sides of the cover plate base is achieved by toning the sealing resin adhesive. If the sealing resin is not used for edge banding of the vertical sides, it will be obvious that the layered lines of different dielectric layers will affect the viewing effect.

### Modified Example 1

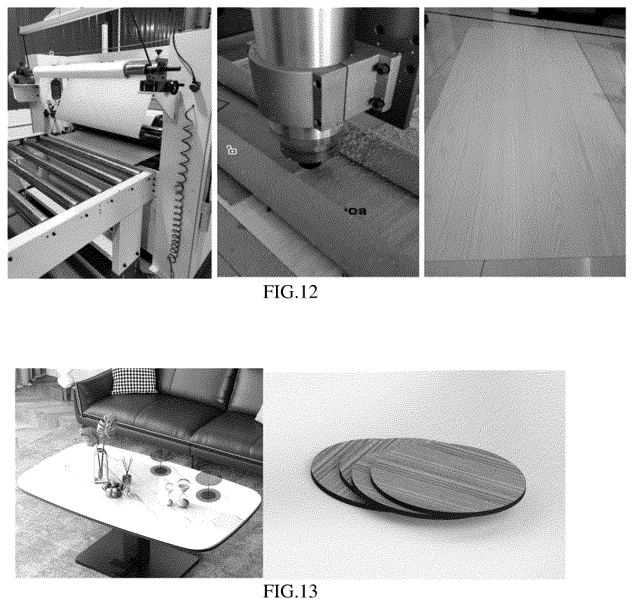

Based on Example 1 or Example 2, an ultra-thin solid wood grain coaster panel with physical temperature control according to the present invention comprises an antibacterial hardened protective coating 1, a transparent protective film layer 2, a first adhesive layer 3, an adhesive adhesion undercoat layer 4, a first pattern printing layer 5, a first printing effect enhancement undercoat layer 6, a UV-sealing coating layer 7, a natural plant epidermis layer 8, a second adhesive layer 9, a second thermal conductive functional layer, a third adhesive layer 12, a filling sheet interlayer 13, a fourth adhesive layer 14, a fourth thermal conductive layer, and a base material layer 20, which are sequentially stacked from bottom to top. As shown in FIG. 12, the base sealing resin adhesive edge-banding layer 19 is surrounded by outer surface layers disposed on the vertical sides of the cover plate base.

The first super thermal conductive functional layer 10 and/or the third super thermal conductive functional layers 15 of the deformed cover plate base are omitted, and a portion of the omitted functional layers will be made of an aluminum foil as the second thermal conductive functional layer 11 and/or the fourth thermal conductive functional layer 16 with a thickness of 0.2 mm, which can be directly used as the heat conduction & dissipation functional layers. Omitting the first super thermal conductive functional layer 10 and/or the third super thermal conductive functional layer 15 enables targeted customization and supply of the present invention for different application scenarios and varying requirements. This enhances the product's adaptability to various scenario applications and meets customer price expectations.

### Modified Example 2

Based on Example 1 or Example 2, an ultra-thin solid wood grain coaster panel with physical temperature control according to the present invention, as shown in FIG. 1, comprises a natural plant epidermis layer 8, a second adhesive layer 9, a first super thermal conductive functional layer 10, a third adhesive layer 12, a second thermal conductive functional layer, a filling sheet interlayer 13, a fourth adhesive layer 14, a third super thermal conductive functional layer 15, a fourth thermal conductive functional layer 16, and a base material layer 20, which are sequentially stacked from bottom to top. A base sealing resin adhesive edge-banding layer 19 is configured to surround and envelop the outer surface layers of the cover plate base.

For the deformed cover plate base, the hardened protective coating, the transparent protective film layer 2, the first adhesive layer 3, the adhesive adhesion undercoat layer 4, the pattern printing layer, the printing effect enhancement undercoat layer, and the UV-sealing coating layer 7 are all omitted. The natural plant epidermis layer 8 is directly used as a decorative pattern substrate for the cover plate base. The upper surface of the natural plant epidermis layer 8 is coated with conventional solid wood sealing or semi-sealing woodworking varnish or solid wood wax oil. While offering visual and tactile effects indistinguishable from conventional solid wood decorative panels, it possesses superior properties and characteristics unmatched by conventional solid wood sheets, including higher density, hardness, tensile strength, and superior heat dissipation and temperature control capabilities. This enables the customization of novel materials tailored to specific application scenarios based on varying requirements.

### Modified Example 3

Based on Example 1 or Example 2, an ultra-thin solid wood grain coaster panel with physical temperature control according to the present invention comprises a second adhesive layer 9, a first super thermal conductive functional layer 10, a third adhesive layer 12, a second thermal conductive functional layer 11, a filling sheet interlayer 13, a fourth adhesive layer 14, a third super thermal conductive functional layer 15, a fourth thermal conductive functional layer 16, and a base material layer 20, which are sequentially stacked from bottom to top. A base sealing resin adhesive edge-banding layer 19 is configured to surround and envelop the outer surface layers of the cover plate base.

For the deformed cover plate base, the antibacterial hardened protective coating 1, the transparent protective film layer 2, the first adhesive layer 3, the adhesive adhesion undercoat layer 4, the pattern printing layer, the printing effect enhancement undercoat layer, the UV-sealing coating layer 7, and the natural plant epidermis layer 8 are all omitted. Instead, a PET colored film or PET solid-color sheet material replaces the natural plant epidermis layer 8 to directly serve as the decorative pattern substrate for the cover plate base. The first adhesive layer 3 is a PUR hot-melt adhesive liquid applied to the PET solid-color sheet on the upper surface of the cover plate base. The processing procedure is to stack the cover plate base on the feeding platform of the laminating machine, inject the PUR hot-melt adhesive solid into the coating raw material tank to be heated and melt at a high temperature to a hot-melt adhesive liquid, and then convey the PUR hot-melt adhesive liquid via the coating conveyor to the coating rubber roller, where it covers the roller surface. Propelled by the power transmission mechanism of the laminating machine, the cover plate base passes through the coating rubber roller, forming an 80 μm-thick, 1.25 m-wide PUR hot-melt adhesive wet film on its surface. The PUR hot-melt adhesive wet film adhered to the upper surface of the first super thermal conductive functional layer 10 of the cover plate base passes through the laminating pressure roller again. During this passage, the PET solid-color sheet base material fixed to the unwinding shaft of the laminating machine, rolls and adheres with the PUR hot-melt adhesive wet film on a surface of the cover plate base under the pressure of the laminating pressure roller. Simultaneously, the laminated cover plate surface undergoes cyclic airflow at an ambient room temperature. It then traverses a high-temperature drying tunnel at a speed of 5~8 m/min to complete adhesion and curing, thereby achieving full lamination of the PET solid-color sheet base onto the first super thermal conductive functional layer 10 of the cover plate base. As compared to conventional decorative panels, the direct replacement of the natural plant epidermis layer 8 with solid-color PET sheets offers higher density, hardness, tensile strength, and super heat conduction & dissipation/temperature control properties. Particularly in terms of heat dissipation and temperature control, it exhibits unmatched performance characteristics unattainable by conventional decorative panels, introducing a novel panel material to the market with broader application scenarios.

### Modified Example 4

Based on Example 1 or Example 2, an ultra-thin wood-grain coaster panel with physical temperature control according to the present invention comprises a hardened protective coating layer, a transparent protective film layer 2, a first adhesive layer 3, an adhesive adhesion undercoat layer 4, a pattern printing layer, a printing effect enhancement undercoat layer, a first super thermal conductive functional layer 10, a third adhesive layer 12, a second thermal conductive functional layer, a heat insulation sheet layer, a fourth adhesive layer 14, a third super thermal conductive functional layer 15, a fourth thermal conductive functional layer, a base sealing resin adhesive edge-banding layer 19, and a base material layer 20, which are sequentially stacked from bottom to top. A base sealing resin adhesive edge-banding layer 19 is configured to surround and envelop the outer surface layers of the cover plate base.

For the deformed cover plate base, both the UV-sealing coating layer 7 and the natural plant epidermis layer 8 are omitted. The printing effect enhancement undercoat layer is directly applied to the upper surface of the first super thermal conductive functional layer 10. The pattern printing layer is then formed on the upper surface of the printing effect enhancement undercoat layer to directly replace the natural plant epidermis layer 8 as the substrate texture. The key advantage of using the above-described alternative process is that the expanded design flexibility for surface patterns and textures on the cover plate base, along with lower costs. As compared to conventional decorative panels, the direct replacement of the natural plant epidermis layer 8 with solid-color PET sheets offers higher density, hardness, tensile strength, and super heat conduction & dissipation/temperature control properties. Particularly in terms of heat dissipation and temperature control, it exhibits unmatched performance characteristics unattainable by conventional decorative panels, introducing more abundant panel materials to the market with broader application scenarios.

### Modified Example 5

Based on Example 1 or Example 2, an ultra-thin solid wood grain coaster panel with physical temperature control according to the present invention omits the second thermal conductive functional layer 11, the third adhesive layer 12, the filling sheet interlayer 13, the fourth adhesive layer 14, and the fourth thermal conductive functional layer 16 of the cover plate base. The omitted functional layers are replaced by a PC polycarbonate panel with a thickness of 0.5 mm to 3 mm, which directly serve as the functional layers. The first super thermal conductive functional layer 10 and the third super thermal conductive functional layer 15 are directly coated onto both front and back sides of the PC polycarbonate panel.

The processing procedure is as shown in FIG. 5. By employing a preferred one of coating, spraying, roller coating or shower coating, a graphene coating liquid is filled into a coating liquid raw material tank. The graphene coating liquid is conveyed by a liquid conveyor to a coating liquid outlet, where it is either applied to a rubber roller surface of the coating machine, or conveyed to a spray atomization port for pressurized atomization and spraying. The aluminum foil roll material of the PC polycarbonate panel is loaded to the unwinding shaft 1 of the coating machine for fixation, or a sheet of the PC polycarbonate panel is place on the feeding platform. Propelled by a conveyor mechanism, the PC polycarbonate panel passes below the surface of the rubber coating roller or downstream of the spray atomization port. As the PC polycarbonate panel passes through a coating processing unit, a graphene heat dissipation coating with a wet film thickness of 100 μm and a width within 1.3 m will form on its front surface. Subsequently, at a speed of 1~3 m/min and a baking temperature set between 70~150 degrees Celsius, the graphene wet film adhered to a surface of the PC polycarbonate panel is fully baked and cured within a high-temperature drying tunnel oven having a length of >25 m for 5~20 minutes, so that the film thickness will become an actual dry film thickness of 20 μm after being rewound. The previous step is repeated to complete graphene layer coating on both front and back sides of the PC polycarbonate panel.

The key advantage of this substitution is that the PC polycarbonate panel serving as the core substrate material exhibits high strength, excellent toughness, heat resistance, deformability, lightweight properties, light transmission, ease of shaping, machinability, and superior flatness. Particularly in terms of heat dissipation and temperature control performance, they possess distinct characteristics unmatched by conventional decorative panels. This innovation introduces more abundant panel materials to the market with broader application scenarios.

### Modified Example 6

Based on Example 1 or Example 2, an ultra-thin wood-grain cup coaster panel with physical temperature control according to the present invention omits the second adhesive layer 9, the first super thermal conductive layer 10, the second thermal conductive layer 11, the third adhesive layer 12, the filling sheet interlayer 13, the fourth adhesive layer 14, and the fourth thermal conductive layer 16 of the cover plate base.

Step S2: preliminary integration process steps are as shown in FIG. 9. A repositionable low-adhesion nano-plate adhesive layer is applied to an upper surface of an 8 mm-thick MDF plate. The natural plant epidermis is placed above the low-adhesion nano-plate adhesive layer with its front side being adhered against the low-adhesion nano-plate adhesive layer. Then, it is placed on the feeding platform of the laminating machine, and the upper surface of the natural plant epidermis is opposite to the direction of the coating rubber roller.

First, the UV adhesive is injected into the coating raw material tank, and then convey the UV adhesive liquid via the coating conveyor to the coating rubber roller, where it covers the roller surface. Propelled by the power transmission mechanism of the laminating machine, the base of the MDF plate adhered with natural plant epidermis passes through the coating rubber roller, forming an 80 μm-thick, 1.25 m-wide UV adhesive wet film on its surface.

After completing the UV adhesive coating process for the adhesive layers, the base of the MDF plate will stop between the coating rubber roller and the laminating pressure roller. The transparent PC polycarbonate panel is laid flat on the upper surface of the natural plant epidermis and adhered to the UV adhesive to move forward, passes through the laminating pressure roller again, and rolls under the pressure of the laminating pressure roller to bond the transparent PC polycarbonate panel to the upper surface of the natural plant epidermis and the UV adhesive wet film. Simultaneously, upon passing through the UV curing machine, the UV adhesive wet film between the transparent PC polycarbonate panel and the natural plant epidermis undergo initial curing and bonding. Subsequently, the UV adhesive liquid undergoes secondary deep curing through the UV curing machine, completing full integration of the transparent PC polycarbonate panel with the natural plant epidermis. The adhered MDF plate is then separated and reused as a serving tray.

The PC polycarbonate panel possesses high light transmittance, allowing UV light to penetrate and fully cure the UV adhesive, thereby achieving the integration with the natural plant epidermis. If a non-transparent PC polycarbonate panel is used, the UV light cannot penetrate, so that the natural plant epidermis cannot bond with the PC polycarbonate panel. The key advantage of using the PC polycarbonate panel is that it has printability, coatability, high strength, excellent toughness, heat resistance, easy fabrication, lightweight properties, light transmission, formability, machinability, high flatness, low cost, convenient packaging, and ease of transportation. Specifically for packaging and transportation, a large-sized finished panel base can be rolled into coils for shipping and unrolled when using. Upon the property of base naturally flattens after unrolling, transit costs and enhancing logistics efficiency are significantly reduced.

Upon completing full integration of the PC polycarbonate panel with the natural plant epidermis, the third super thermal conductive functional layer 15 is formed. The substrate for the third super thermal conductive functional layer 15 is made by using graphene as the core high conductivity material. Its manufacturing process and performance are same as the previously described graphene coating process, thus requiring no further elaboration. The difference lies in that the PC polycarbonate panel undergoes coating after integration of the natural plant epidermis. The coated graphene coating layer is applied to the opposite side of the natural plant epidermis, ultimately forming the third super thermal conductive functional layer 15. However, the first super thermal conductive functional layer 10 will be omitted. After being omitted, while this configuration does not match the thermal performance of double-sided graphene, the single-sided third super thermal conductive functional layer 15 remains sufficient for general applications. This approach introduces more abundant panel materials to the market with broader application scenarios.

### Principle Explanation

When the local surface temperature at the center of the natural plant epidermis layer 8 reaches a high temperature of ≥100° C., the first graphene heat conduction & dissipation functional layer serving as the substrate layer for the natural plant epidermis layer 8 will immediately detect the central temperature through the natural plant epidermis layer 8. The detected high temperature will then conduct laterally outward through the first graphene heat conduction & dissipation functional layer. Simultaneously, the heat is conducted, diffused, radiated, and exchanged vertically upward through the natural plant epidermis layer 8 with the external environment, thereby achieving the initial stage of cooling and temperature control. While exchanging the heat vertically upward, it simultaneously transfers the heat vertically downward to the aluminum foil of the second thermal conductive functional layer serving as the thermal conductive medium layer, and distributes the absorbed heat laterally in all directions to achieve the second stage of cooling and temperature control. While conducting the heat laterally, it simultaneously transfers the heat vertically downward through the filling sheet interlayer 13 to the third graphene heat conduction & dissipation functional layer. This layer then conducts the heat laterally outward, achieving the third stage of cooling and temperature control. While conducting the heat laterally, it simultaneously conducts the heat vertically downward to the fourth thermal conductive functional layer. From there, the heat is conducted laterally outward, achieving the fourth stage of cooling and temperature control. While conducting the heat laterally, it simultaneously conducts residual heat vertically downward through the anti-slip ink printing layer to the protected solid surface, achieving the fifth stage of cooling and temperature control. The fourth thermal conductive functional layer adheres to the protected solid surface through the anti-slip ink printing layer. Utilizing the natural ambient temperature of the protected solid surface, the fourth stage of ultimate cooling and temperature control effect is achieved. Through this four-stage sequential cooling and temperature control process, heat at the center of the natural plant epidermis layer 8 undergoes continuous multi-layered sequential lateral and vertical synchronous heat conduction, heat diffusion, heat radiation, and heat exchange. This can achieve a 15-30% reduction in temperature at the center point of the top natural plant epidermis layer 8, with a cooling speed of <0.5 seconds. The temperature of the protected solid surface at the bottom layer decreases by 30-45%, with a cooling speed of <0.5 seconds.

After cold-hot pressing integration of the second thermal conductive layer, the filling sheet interlayer 13, and the fourth thermal conductive functional layer disposed below the natural plant epidermis layer 8, the three-layer substrate achieves maximum density, hardness, strength, and rigidity, thereby achieving a tension restraint and tensile balance effect between upper and lower layers. This ultimately resolves such issues as banana-curve deformation, edge curling, unevenness, and poor adhesion occurred in the solid wood grain coaster panel. When specifically used as a solid wood grain coaster panel covering tabletops, the solid wood grain coaster panel's seamless adhesion, flatness, gap-free fit, and ultra-lightweight high-hardness characteristics become particularly crucial.

In summary, when a 100° C. hot water or a high-temperature object of ≥100° C. is placed on the upper surface of the natural plant epidermis layer 8, and its heat is transferred to the lower-layer tabletop coaster panel, the heat undergoes four-stage controlled cooling through the functional layers of the tabletop panel base. This protects the solid wood tabletop and the cover plate base from scorching, scratching, blistering, oil stains, and other issues. This extends the lifetime of the ultra-thin solid wood grain coaster panel with physically temperature control according to the present invention, while enhancing its broader application adaptability and practicality.

In the description of the present application, it should be understood that orientation or positional relationships indicated by terms such as “upper”, “lower” “front”, “back”, “left”, “right”, “vertical”, “horizontal”, “top”, “bottom”, “inside”, “outside”, and the like are based on those shown in the accompanying drawings. These are provided solely for the purpose of facilitating the description of the present application and simplifying the description, and are not intended to indicate or imply that the devices or elements referred to must have a specific orientation, be constructed in a specific orientation, or operate in a specific orientation. Therefore, they should not be construed as limitations on the present application.

The above describes specific examples of the present invention. It should be understood that the present invention is not limited to the specific examples described above. Those skilled in the art may make various changes or modifications within the scope of the appended claims without departing from the spirit and scope of the invention. The examples of the present application and features thereof may be arbitrarily combined with one another without conflicting.

What is claimed is:

1. A solid wood grain pad structure, characterized in that, the structure comprises: a protective layer, a first adhesive layer, an adhesive adhesion undercoat layer, a first pattern effect layer, a UV-sealing coating layer, a natural plant epidermis layer, a second adhesive layer, a first thermal conductive layer, a third adhesive layer, a filling sheet interlayer, a fourth adhesive layer, and a second thermal conductive layer, which are sequentially disposed from top to bottom; and
a base sealing resin adhesive edge-banding layer surroundingly adhered to surface layers around outer vertical sides of a pad base.

2. The solid wood grain pad structure as claimed in claim 1, characterized in that, a second pattern effect layer is further disposed below the second thermal conductive layer;
or, a base material layer is further disposed below the second thermal conductive layer.

3. The solid wood grain pad structure as claimed in claim 2, characterized in that, the protective layer comprises a transparent protective film layer and an antibacterial hardened protective layer sequentially disposed from bottom to top above the first adhesive layer;
the first pattern effect layer comprises a first printing effect enhancement undercoat layer and a first pattern printing layer sequentially disposed from bottom to top above the UV-sealing coating layer;
the second pattern effect layer comprises a second printing effect enhancement undercoat layer and a second pattern printing layer sequentially disposed from top to bottom below the second thermal conductive layer;
the base material layer comprises one or more of a composite cork, a rubber soft magnetic sheet, a felt fabric, a solid-color or faux textured plastic sheet, a solid-color or faux textured metal sheet, a PC plastic plate, a water-absorbing and anti-slip material.

4. The solid wood grain pad structure as claimed in claim 1, characterized in that, the first thermal conductive layer comprises a first graphene heat conduction & dissipation functional layer and a second metal foil layer sequentially disposed from top to bottom;
the second thermal conductive layer comprises a third graphene heat conduction & dissipation functional layer and a fourth metal foil layer sequentially disposed from top to bottom.

5. A method of manufacturing a solid wood grain pad structure, characterized in that, the method is used for manufacturing the solid wood grain pad structure as claimed in claim 1, and comprises the following steps:
a step S1 of material preparation:
pre-processing a PET transparent protective film to form the protective layer;
performing seam processing on a natural plant epidermis to form the natural plant epidermis layer;
processing a metal foil to form the first thermal conductive layer or the second thermal conductive layer; and
processing an interlayer sheet to form the filling sheet interlayer;
a step S2 of preliminary integration:
stacking the natural plant epidermis layer, the first thermal conductive layer, the filling sheet interlayer, and the second thermal conductive layer prepared in the step S1 sequentially from top to bottom and bonding by using an adhesive to form a cover plate base, forming the UV-sealing coating layer on an upper surface of the natural plant epidermis layer of the cover plate base, then forming the first printing effect enhancement undercoat layer on an upper surface of the UV-sealing coating layer, and forming the first pattern printing layer on an upper surface of the first printing effect enhancement undercoat layer after pattern printing;
a step S3 of protective film lamination:
forming the adhesive adhesion undercoat layer on an upper surface of the first pattern printing layer of the cover plate base from the step S2, and adhering the protective layer from the step S1 to the adhesive adhesion undercoat layer;
a step S4 of secondary integration:
forming a pressure-sensitive adhesive layer on an upper surface of the functional base material, then adhering the second thermal conductive layer of the cover plate base with the protective layer from the step S3 to the pressure-sensitive adhesive layer and laminating.

6. The method of manufacturing a solid wood grain pad structure as claimed in claim 5, characterized in that, for the step S1,
the pre-processing of the PET transparent protective film to form the protective layer, comprises the following sub-steps:
a step S1.1.1 of feeding the PET transparent protective film to be processed through an unwinding shaft and a pressure roller, performing corona or coating processing before being rewound, and completing the corona or coating processing on one side of an upper surface of the PET transparent protective film; and
a step S1.1.2 of applying a hardening solution via roller coating, spraying, or shower coating to the one side of the PET transparent protective film that completed the corona or coating processing, and forming the antibacterial hardened protective layer after drying and curing;
the performing of the seam processing on the natural plant epidermis to form the natural plant epidermis layer, comprises a sub-step S1.2.1 of aligning multiple natural plant epidermises from edge to edge to perform seam adhesion;
the processing of the metal foil to form the first thermal conductive layer or the second thermal conductive layer, comprises the following sub-steps:
a step S1.3.1 of performing a frosting treatment on both front and back surfaces of the metal foil to polish a smooth surface of the metal foil into a rough surface;
a step S1.3.2 of applying a heat dissipation ink via roller coating, spraying, or shower coating to one rough surface of the metal foil treated in the step S1.3.1 to form the first super thermal conductive functional layer; and
a step S1.3.3 of performing cutting to obtain the first thermal conductive layer or the second thermal conductive layer;
the processing of the interlayer sheet to form the filling sheet interlayer, comprises a sub-step S1.4.1 of forming a corona-treated layer on both upper and lower surfaces of a plastic interlayer sheet roll respectively to complete the processing of the filling sheet interlayer.

7. The method of manufacturing a solid wood grain pad structure as claimed in claim 5, characterized in that, for the step S3, it comprises the following sub-steps:
a step S3.1 of performing adhesion agent coating on the upper surface of the first pattern printing layer of the cover plate base from the step S2, then performing UV light curing to form the adhesive adhesion undercoat layer; and
a step S3.2 of coating a UV liquid transparent adhesive between the protective layer and the adhesive adhesion undercoat layer, then performing the UV light curing to complete the integration and processing of the protective layer.

8. The method of manufacturing a solid wood grain pad structure as claimed in claim 5, characterized in that, for the step S4, it comprises the following sub-steps:
a step S4.1 of stacking a base of the functional base material onto a feeding platform of a flat laminating machine, loading a pressure-sensitive adhesive roll onto a material unwind air-cushion shaft of the laminating machine for fixation, adhering an upper surface of the functional base material against a pressure-sensitive adhesive surface and synchronously entering and passing through a pressure-sensitive adhesive cold-press composite roller, thereby forming the pressure-sensitive adhesive layer on the upper surface of the functional base material; and
a step S4.2 of adhering the second thermal conductive layer of the cover plate base with the protective layer from the step S3 to the pressure-sensitive adhesive layer and synchronously entering and passing through the cold-press composite roller, thereby completing the integration and processing of the functional base material and the cover plate base.

9. The method of manufacturing a solid wood grain pad structure as claimed in claim 5, characterized in that, the method further comprises a step S5 of profiling:
engraving or punching the cover plate base from the step S4 after the secondary integration according to a preset pattern, and polishing peripheral vertical sides of the engraved or punched cover plate base.

10. The method of manufacturing a solid wood grain pad structure as claimed in claim 9, characterized in that, the method further comprises a step S6 of sealing:
applying a sealing resin adhesive to the peripheral vertical sides of the cover plate base polished in the step S5 to form the base sealing resin adhesive edge-banding layer.
